(19) United States
(12) Patent Application Publication
(10) Pub. No.: US 2013/0110691 A1
(43) Pub. Date: May 2, 2013

(54) Futures Contracts Spread Packages

(71) Applicants: John Nyhoff, Darien, IL (US); John Labuszewski, Westmont, IL (US); Richard Co, Chicago, IL (US); Xing Su, Chicago, IL (US)

(72) Inventors: John Nyhoff, Darien, IL (US); John Labuszewski, Westmont, IL (US); Richard Co, Chicago, IL (US); Xing Su, Chicago, IL (US)

(73) Assignee: CHICAGO MERCANTILE EXCHANGE, INC., Chicago, IL (US)

(21) Appl. No.: 13/285,538

(22) Filed: Oct. 31, 2011

(51) Int. Cl. G06Q 40/06

(52) U.S. Cl. 705/35

(57) ABSTRACT

Futures contract types forming opposing legs of a spread package type can be weighted by the degree to which return rates of subject matters of those legs vary relative to a benchmark. Individual spread package instances of the spread package type can be traded based on bids and/or offers specifying a price spread.

### BACKGROUND

Participants in exchanges and other markets routinely buy, sell and otherwise deal in multi-laterally traded futures contracts. Such contracts may be standardized according to a contract type established by an exchange. Among other things, the contract type may specify an underlying subject matter. As but one example, that subject matter may be an agricultural or other type commodity. In such a case, the contract type may further specify delivery of a predefined amount of that commodity at a predefined future date. As yet another example, the subject matter may be a currency, a market index, an interest rate or other economic subject matter. In such a case, the contract type may further specify payment on a predefined date of an amount computed from the value of the contract subject matter on some future date.

There are two counterparties to a futures contract. A “long” or a “long counterparty” usually refers to a counterparty holding a long position. A long agrees to pay a contract price in return for some deliverable based on the contract subject matter. That deliverable might be physical delivery of a contract commodity on a future date, payment on a future date based on a future price of the contract subject matter, etc. A “short” or a “short counterparty” usually refers to a counterparty holding a short position. A short agrees to receive the contract price at the predefined future date in return for the deliverable based on the contract subject matter.

For each multi-laterally traded futures contract, there is a long counterparty and a short counterparty. Generally, however, either the long or the short of each such contract is an exchange or clearinghouse. For example, a first counterparty may offer to sell a particular type of futures contract through an exchange. After the exchange publishes that offer, a second counterparty may purchase a futures contract of that type through the exchange at the offered price. The exchange then establishes a first contract in which the first counterparty is the short and the exchange clearinghouse is the long, and an offsetting second contract in which the second counterparty is the long and the exchange is the short, with the contract price of the first and second contracts (the accepted offer price of the first counterparty) being the same. The first and second counterparties typically do not know each other's identities.

Some market participants trade in futures contracts based on a spread between long and short positions in separate contracts. For example, a trader may hold a long position in one or more contracts having a first market index as the subject matter (e.g., the Standard & Poor's 500, or “S&P 500”) and a short position in one or more additional contracts having a second market index as the subject matter (e.g., the Dow Jones Industrial Average, or DJIA). A component transaction of a spread (i.e., one of the long or short positions) is typically referred to as a “leg.”

Spread trading in futures contracts offers numerous advantages. For example, spread-based trading can permit profit from relative value opportunities. Notwithstanding this and other advantages, however, there remains room for innovation with regard to techniques by which spread-based trading can be implemented.

### SUMMARY

This Summary is provided to introduce a selection of concepts in a simplified form that are further described below in the Detailed Description. This Summary is not intended to identify key or essential features of the invention.

In at least some embodiments, a futures contracts spread package type can be defined. As part of that definition, futures contract types forming opposing legs of the spread package type can be weighted by the degree to which return rates of the subject matters of those legs vary relative to a benchmark. Weighting based on notional values of the opposing legs can also be performed. The benchmark can be a stock market index, some other type of published index, or other type of economic value that varies over time. Once the spread package type is created, individual spread package instances thereof can be traded based on bids and/or offers specifying a price spread.

Embodiments include methods for creating spread package types and/or for trading instances thereof, computer systems configured to perform such methods, and computer-readable media storing instructions that, when executed, cause a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows a computer system and network in which one or more aspects of the invention may be implemented.

FIG. 2 is a block diagram of a system, according to some embodiments, configured to perform various operations in connection with creating futures contracts spread packages.

FIGS. 3A and 3B illustrate operations, according to some embodiments, for creating futures contracts spread packages.

FIG. 4 illustrates operations, according to at least some embodiments, for trading futures contract spread packages.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, and/or any combination thereof.

Aspects of method steps described in connection with one or more embodiments may be executed on one or more processors associated with a computer system (such as exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

Exemplary Operating Environment

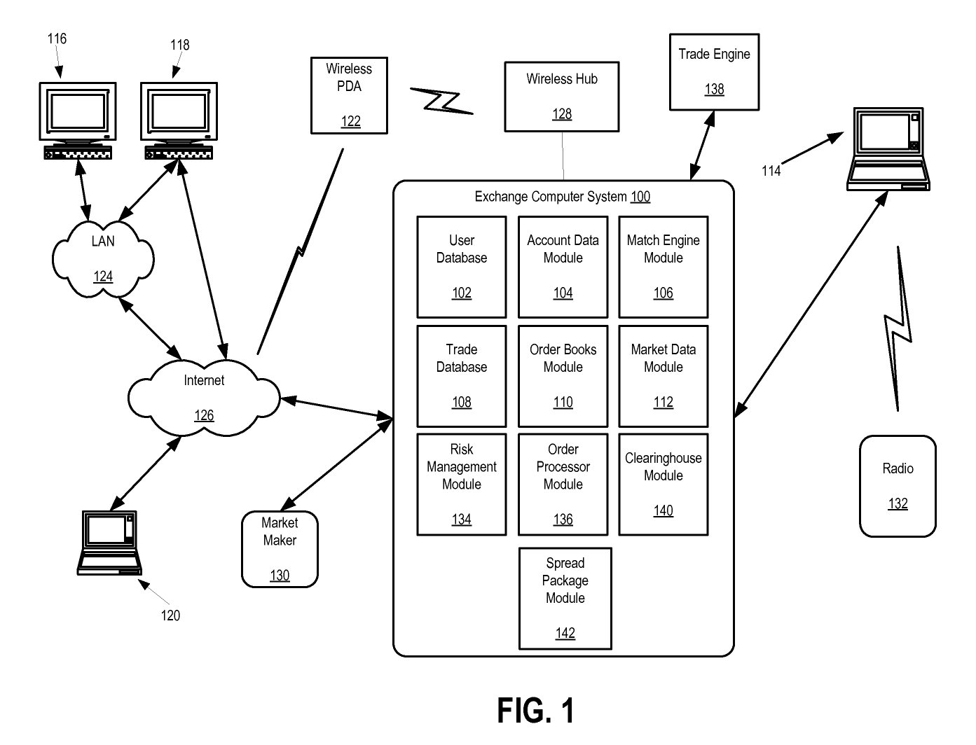

Aspects of at least some embodiments can be implemented with computer systems and computer networks that allow users to exchange trading information. An exemplary trading network environment for implementing trading systems and methods according to at least some embodiments is shown in FIG. 1. The implemented trading systems and methods can include systems and methods that create and/or trade futures contracts spread packages such as are discussed in more detail below.

Computer system 100 can be operated by a financial exchange. Computer system 100 receives orders, transmits market data related to orders and trades to users, and performs other operations associated with a financial exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to store and/or compute (or otherwise determine) current bid and offer prices. A market data module 112 may be included to collect market data, e.g., data regarding current bids and offers for futures contracts, futures contracts spread packages, options and other derivative products. Module 112 may also prepare the collected market data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

A clearinghouse module 140 may be included as part of exchange computer system 100 and configured to carry out clearinghouse operations. Module 140 may receive data from trade database 108 regarding trades of futures contracts and other financial instruments and facilitate the financial exchange acting as one of the parties to every traded contract or other instrument. For example, computer system 100 may match an offer by party A to sell a futures contract for commodity X with a bid by party B to purchase a futures contract for commodity X. Module 140 may then create a first commodity X futures contract between party A and the financial exchange and an offsetting second commodity X futures contracts between the financial exchange and party B. Module 140 may also be configured to perform other clearinghouse operations. As another example, module 140 may maintain margin accounts for member brokers. In those accounts, module 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc.

A futures contracts spread package module 142 may also be included in computer system 100. Module 142 may perform various data collection, calculation and other operations associated with creating futures contracts spread packages. Exemplary futures contracts spread packages and operations associates with creation and/or trading of such packages are discussed below.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on non-transitory computer-readable media. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, one or more computer systems create spread package types and/or trade futures contracts spread packages in a manner that helps facilitate enhanced spread-based trading. For convenience, such packages of futures contracts are referred to herein as “futures contracts spread packages” or “spread packages.” In certain embodiments, a method for creating spread package types and/or for trading spread package instances of that type includes determining a risk factor for two types of contracts that will form opposing legs of the spread. This risk determination, as well as notional values of the two types of contracts, may then be used to calculate the ratio of contracts on each side of the spread.

As an initial illustration, an exchange may consider offering a spread package based on two types of contracts. The first contract type (“type 1”) may have a notional value that is approximately twice the notional value of the second contract type (“type 2”). However, type 1 contracts may have a risk factor that is two thirds the size of a risk factor attributable to type 2 contracts. Using methods according to at least some embodiments, each side of a spread package of type 1 and type 2 contracts could be weighted based on notional values and risk factors. To weight the spread package based on notional values, the spread package might include two type 2 contracts for every type 1 contracts. To weight the spread based on risk factors, the spread package might include three type 1 packages and two type two packages. The combined weighting based on both notional values and risk factors might thus result in a spread package that includes three type 1 contracts (1*3) and four type two contracts (2*2). Additional aspects of this weighting are discussed below.

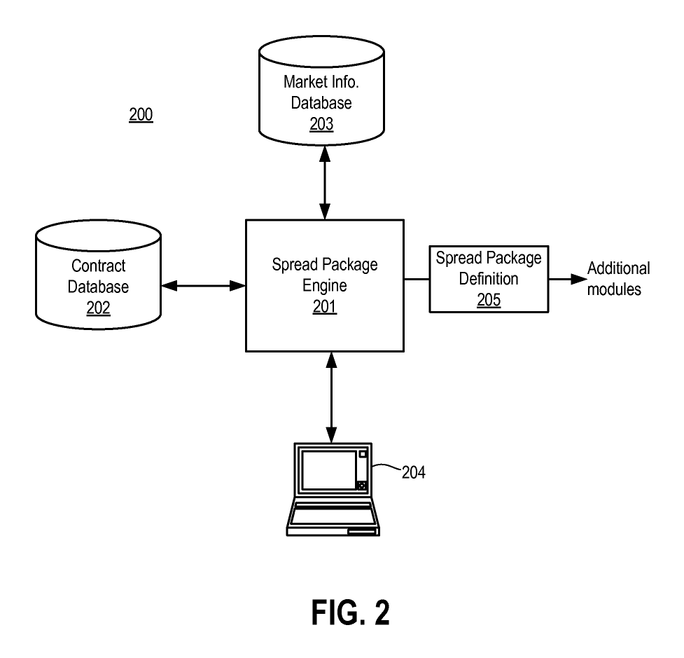

FIG. 2 is a block diagram of a system 200, according to some embodiments, that is configured to perform various operations in connection with creating futures contracts spread packages. System 200 may be spread package module 140 (FIG. 1), may be implemented as a standalone computer (or computer system), or may be implemented as part of another system.

Spread package engine 201, which may be implemented in the form of one or more microprocessors executing program instructions, interfaces and exchanges data with and one or more futures contracts databases 202. Database 202 maintains information regarding various types of futures contracts and other derivatives. The data stored in database 202 may include data defining each of numerous multi-laterally traded futures contract types. For each defined contract type, the data in database 202 may define a subject matter. For some contract types, that data may specify the subject matter to be a physical commodity such as an agricultural commodity, an energy commodity, a metal, etc. For other contract types, that data may specify the subject matter to be a currency, an interest rate, a stock or other market index, a collection of equity securities, a collection of notes or other instruments, etc. Data for still other contract types may specify other types of subject matter or combinations of subject matters. The contract type data may also specify a contract size for each type of contract. For some contract types, the size may be an amount of a commodity that must be delivered. For other contract types, the size may be a cash value of a subject matter on a future date, or some multiple of a subject matter cash value on a future date. Database 202 may be implemented as a distributed database residing in one or more of the modules of exchange computer system 100 (FIG. 1), may be implemented as a one or more software routines configured to extract data from one or more of said modules, may be implemented as a standalone database accessible over the Internet or other wide area network, or may be implemented in other ways.

Spread package engine 201 also interfaces with one or more market information databases 203. Database 203 stores information regarding values of the subject matters of various contract types during preceding periods. Data in database 203 could include values for various market indices (e.g., the S&P 500, the DJIA) at previous times, information regarding values for specific stocks, commodities, and other subject matters at previous times, etc. Database 203 could be a part of exchange computer system 100 and/or could comprise links to one or more external databases and/or market information services.

Engine 201 may receive various types of input via one or more computers 204. For example, a human user of computer 204 may provide input that causes computer 204 to communicate with engine 201, which communication(s) cause(s) engine 201 to create a particular type of futures contract spread package. Such input could include an identification of contract types that may form opposing legs of the spread package, identification of various benchmark indices to be used in determining risk factors, and/or other parameters associated with spread package creation. As another example, a user of computer 204 might input instructions that cause engine 201 to retrieve data from database 202 and/or database 203 and output the retrieved data to the user. The user could then continue to interact with engine 201 during the spread package creation process by approving values for various parameters, manually inputting parameter values, and/or otherwise providing input to engine 201.

Once engine 201 has created a futures contracts spread package type, a definition 205 of that spread package type is forwarded to other modules of exchange computer system 100. Definition 205 then allows those other modules to facilitate trading in spread packages of the defined type, as discussed more fully below.

Computer 204 may be the same computer on which engine 201 executes and/or may also house one or more of databases 202 and 203. Alternatively, any or all of engine 201, database 202 and database 203 could execute or reside on computers separate from computer 204, with computer 204 communicating with those separate computers over one or more local and/or wide area networks.

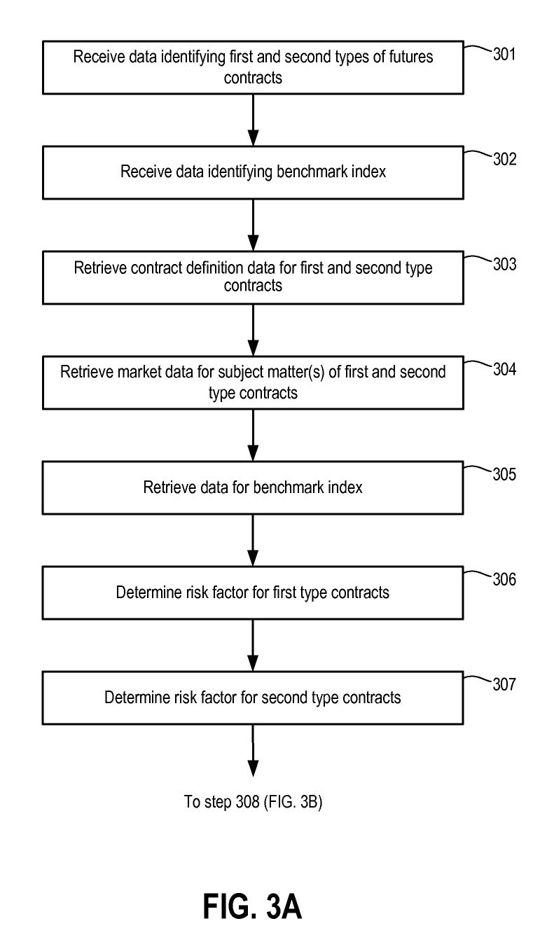

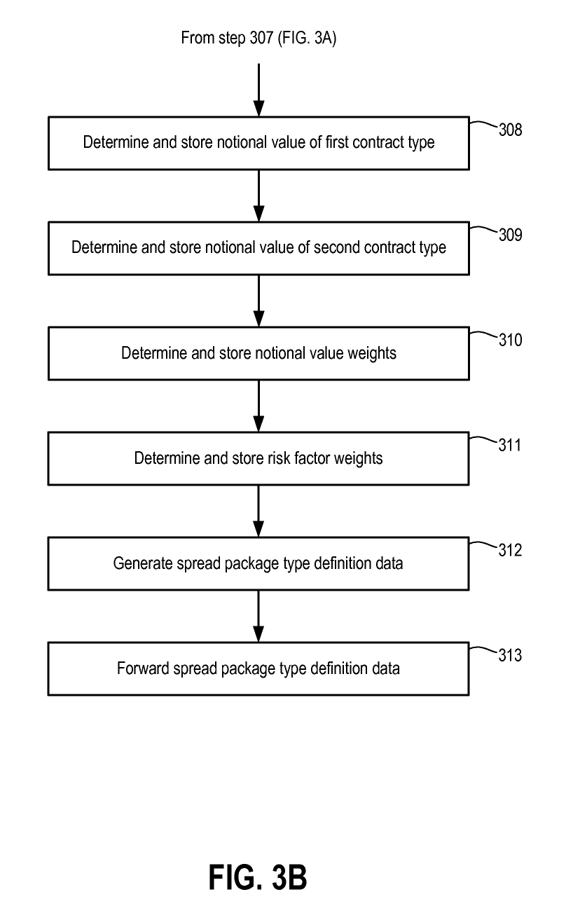

FIGS. 3A and 3B are a flow chart showing operations in performed by system 200, according to some embodiments, in connection with creating a type of futures contracts spread package. Once the spread package type is created, individual instances of that type (i.e., individual spread packages of the created type) can be traded. For purposes of explanation, the operations of FIGS. 3A and 3B are described using two types of equity index futures contracts and various specific parameter values as examples. The examples used to illuminate the discussion of FIGS. 3A and 3B are not intended as limitations on the types of contracts or ranges of values that might be associated with spread package type creation in other embodiments. Additional non-limiting examples of the types of contracts that might be used to create spread package types are included below.

In step 301, spread package engine 201 receives data identifying first and second types of futures contracts that may be used to form opposing legs of a spread package. Engine 201 may receive this data, e.g., as a result of user input to computer 204.

In the current example, it is assumed that the data received in step 301 identifies type A and type B futures contracts. This example further assumes that the subject matter of each type A contract is a hypothetical stock collection A. Hypothetical stock collection A (or “collection A”) includes a share of common stock in each of multiple corporations. A long counterparty to a type A contract agrees to pay the contract price in return for payment, on a final settlement date, of a final settlement value. A short party to a type A contract agrees to pay the final settlement value on the final settlement date in return for payment of the contract price. The final settlement value is calculated by summing the closing trade prices, as of a final value calculation date, of each stock in collection A and then multiplying that sum by a multiplier M_{A}. Database 202 stores a type A contract definition that includes data specifying the stocks in collection A, the final settlement date for type A contracts, the final value calculation date for type A contracts, the value of multiplier M_{A}, and other parameters applicable to each type A contract. The contract price of an instance of a type A contract would be determined, at the time such contract is entered, based on matching of bid and ask prices of traders utilizing exchange computer system 100.

The current example further assumes that the subject matter of each type B contract is a hypothetical stock collection B (“collection B”). Collection B includes stocks not included in collection A, and vice versa. A long counterparty to a type B contract agrees to pay the contract price in return for payment, on a final settlement date, of a final settlement value. A short party to a type B contract agrees to pay the final settlement value on the final settlement date in return for payment of the contract price. The final settlement value is calculated by summing the closing trade prices, as of a final value calculation date, of each stock in collection B and then multiplying that sum by a multiplier M_{B}. Database 202 also stores a type B contract definition that includes data specifying the stocks in collection B, the final settlement date for type B contracts (which might be different from the type A contract final settlement date), the final value calculation date for type B contracts (which might be different from the type A contract final value calculation date), the value of M_{B} (which might be different from the value of M_{A}), and other parameters applicable to each type B contract. The contract price of an instance of a type B contract would similarly be determined, at the time such contract is entered, based on matching of bid and ask prices of traders utilizing exchange computer system 100.

In step 302, engine 201 receives data identifying a benchmark index. As with the identification of futures contract types received in step 301, the data identifying the benchmark index could be, e.g., a result of user input to computer 204. In the current example, the identified benchmark index is the S&P 500.

In step 303, engine 201 retrieves contract definition data for the first and second contract types identified in step 301. Engine 201 retrieves this data from database 202. In the current example, engine 201 retrieves the type A contract definition data and the type B contract definition data described above.

In step 304, engine 201 retrieves historical market data from database 203 for the subject matters of the first and second contract types identified in step 301. In the current example, engine 201 retrieves historical price data for each stock in collections A and B. That historical data could include, for each of those stocks, the closing price on each trading day in an immediately preceding period T. The length of period T is assumed to be one year in the current example.

In step 305, engine 201 retrieves historical data from database 203 for the benchmark index identified in step 302. In the current example, that data could include the closing value of the S&P 500 on each trading day during the same period for which data was retrieved in step 304.

In step 306, engine 201 determines a risk factor of the first contract type identified in step 301 relative to the benchmark index identified in step 302. In some embodiments, engine 201 determines a risk factor for an arbitrary type of contract K, relative to an arbitrary benchmark index BI during an evaluation period, using a univariate linear regression equation in the following form: R_{K}(t)=α_{K}+β_{K}*R_{BI}(t)+ε_{K}. The dependent variable “R_{K}(t)” is a daily rate of return for a K contract subject matter as of a trading day t. Engine 201 calculates R_{K}(t) by first computing V_{K}(t), a value of the K contract subject matter based on data for a trading day t during the evaluation period T, and V_{K}(t−1), a value of the K contract subject matter based on data for an immediately preceding trading day t−1. Engine 201 then calculates R_{K}(t) as the percentage change in subject matter value from day t−1 to day t (e.g., [V_{K}(t)−V_{K}(t−1)]/[V_{K}(t−1)]). The independent variable R_{BI}(t) represents a daily return of the benchmark index as of day t. Engine 201 calculates R_{BI}(t) by first determining the values of that benchmark index on days t and t−1 (BI(t) and BI(t−1), respectively). Engine 201 then calculates R_{BI}(t) as the percentage change from day t−1 to day t (e.g., [BI(t)−BI(t−1)]/[BI(t−1)]). The univariate linear regression slope parameter β_{K} is the risk factor. The terms α_{K} and ε_{K} are the univariate linear regression intercept and error terms, respectively.

Using data retrieved in step 303 (e.g., data specifying the subject matter of the first type contract), 304 (historical market data for the first type contract subject matter) and 305 (historical benchmark index data), engine 201 generates an array of R_{BI}(t) vs. R_{K}(t) values for each of multiple times t during the period T. With that array of values, engine 201 then calculates α_{K}, β_{K} and ε_{K} using a least squares analysis or any of other well-known computational algorithms for calculating these parameters. After calculating α_{K}, β_{K} and ε_{K}, engine 201 stores the ε_{K} value as the risk factor for type K contracts.

In the current example of type A contracts, the equation “R_{K}(t)=α₁+β_{K}*R_{BI}(t)+ε_{K}” becomes the equation “R_{A}(t)=α_{A}+β_{A}*R_{S&P500}(t)+ε_{A}” in step 306. For each trading day t in the period T, engine 201 maps a value for the daily return of the S&P 500 (“R_{S&P500}(t)”) to the daily return of stock collection A, the type A contract subject matter (“R_{A}(t)”). Engine 201 calculates R_{A}(t) for each day t by computing V_{A}(t), computing V_{A}(t−1) and computing [V_{A}(t)−V_{A}(t−1)]/[V_{A}(t−1)]. Engine 201 calculates V_{A}(t) by summing the date t closing trade prices of each stock in collection A and calculates V_{A}(t-1) by summing the date t−1 closing trade prices of each stock in collection A. Engine 201 calculates R_{S&P500}(t) for each day t by determining the value of the S&P 500 on days t and t−1 (S&P500(t) and S&P500(t−1), respectively) and then calculating [S&P500(t−1)−S&P500(t)]/[S&P500(t−1)]. After creating an array of R_{S&P500}(t) vs. R_{A}(t) values, engine 201 calculates α_{A}, β_{A} and ε_{A} and stores β_{A} as the risk factor for type A contracts. The current example assumes that engine 201 calculates and stores a β_{A} of 0.8

In step 307, engine 201 determines a risk factor of the second contract type identified in step 301 relative to the benchmark index identified in step 302 in a manner similar to that used in step 305, but using data from steps 303 and 304 applicable to the second contract type. In the current example of type B contracts, “R_{K}(t)=α_{K}+β_{K}*R_{BI}(t)+ε_{K}” becomes “R_{B}(t)=α_{B}+β_{B}*R_{S&P500}(t)+ε_{B}” in step 307. Engine 201 calculates β_{B} in a manner similar to that described above for type A contracts during step 305, but using data from steps 303 and 304 relevant to type B contracts. The current example assumes that engine 201 calculates and stores a β_{B} of 1.2.

In step 308, engine 201 determines and stores a notional value N₁ of the first contract type identified in step 301. Notional values of futures contracts can be defined in various ways. The manner in which a notional value is to be calculated can be included in the first contract type definition data retrieved in step 303. In the current example, engine 201 calculates a notional value N_{A} for type A contracts by determining a daily settlement value (based on the type A contract definition data retrieved in step 303) using current values of the stocks in collection A and the multiplier M_{A}. The current example assumes that engine 201 determines and stores an N_{A} of $101,000.

In step 309, engine 201 determines and stores a notional value N₂ of the second contract type identified in step 301 using a methodology defined by the second contract type definition data received in step 303. The value can also be calculated using any of various techniques. In the current example, engine 201 calculates a notional value N_{B} for type B contracts by determining a daily settlement value (based on the type B contract definition data retrieved in step 303) using current values of the stocks in collection B and the multiplier M_{B}. The current example assumes that engine 201 determines and stores an N_{B} of $50,000.

In step 310, engine 201 determines and stores weights based on the notional values determined in steps 308 and 309. In some embodiments, engine 201 performs notional value weighting by determining integers m and n such that m*N₁ is approximately equal to n*N₂ (m*N₁≈n*N₂). In some such embodiments, engine 201 chooses m and n such the ratio (m*N₁)/(n*N₂) is greater than about 0.9 and is less than about 1.1. Depending on the degree to which notional value balancing is deemed important by operators of system 200, the range of values for the ratio (m*N₁)/(n*N₂) could be expanded (e.g., between about 0.83 and about 1.2, between about 0.8 and about 1.25) or narrowed (e.g., between about 0.95 and about 1.05). The current example assumes that engine 201 determines and stores a notional value weight m_{A}=1 for type A contracts and a notional value weight n_{B}=2 for type B contracts.

In some embodiments, engine 201 may perform step 310 automatically. As but one example of an algorithm that could be used so as to achieve m*N₁≈n*N₂, engine 201 could iteratively compute (m*N₁)/(n*N₂) using all possible combinations of m and n where m =1, 2, . . . 10 and n=1, 2, . . . 10, then select the combination of m and n values that caused the ratio (m*N₁)/(n*N₂) to be within the desired range (e.g., between 0.9 and 1.1, etc.) and closest to 1. If no combination of an integer m value between 1 and 10 and an integer n value between 1 and 10 causes the ratio (m*N₁)/(n*N₂) to be within the desired range (e.g., if N₁ is significantly larger than 10*N₂ or vice versa), engine 201 could output an error message to computer 204 and request further user input. In such a circumstance, the user might manually input values for m and n, might restart the process by choosing new first and/or second futures contract types, or take other action.

In step 311, engine 201 determines and stores weights based on the risk factors determined in steps 305 and 306. In some embodiments, engine 201 performs risk factor weighting by determining integers p and q such that p*β₁ is approximately equal to q*β₂ (p*β₁≈q*β₂). In some such embodiments, and similar to step 310, engine 201 chooses p and q such the ratio (p*β₁)/(q*β₂) is greater than about 0.9 and is less than about 1.1. Depending on the degree to which risk factor balancing is deemed important by operators of system 200, the range of values for the ratio (p*β₁)/(q*β₂) could be expanded (e.g., between about 0.83 and about 1.2, between about 0.8 and about 1.25) or narrowed (e.g., between about 0.95 and about 1.05). The current example assumes that engine 201 calculates a risk factor weight p_{A}=3 for type A contracts and a risk factor weight q_{B}=2 for type B contracts.

As with step 310, engine 201 may perform step 311 automatically in some embodiments. As but one example of an algorithm that could be used so as to achieve p*β₁≈q*β₂, engine 201 could iteratively compute (p*β₁)/(q*β₂) using all possible combinations of p and q where p=1, 2, . . . 10 and q=1, 2, . . . 10, then select the combination of p and q values that caused the ratio (p*β₁)/(q*β₂) to be within the desired range (e.g., between 0.9 and 1.1, etc.) and closest to 1. If no combination of an integer p value between 1 and 10 and an integer q value between 1 and 10 causes the ratio (p*β₁)/(q*β₂) to be within the desired range, engine 201 could output an error message to computer 204 and request further user input. In such a circumstance, the user might manually input values for p and q, might restart the process by choosing new first and/or second futures contract types, or take other action.

In step 312, engine 201 generates definition data for the futures contracts spread package type being created. That data specifies that each spread package of the defined spread package type includes positions in r contracts of the first type identified in step 301 and opposing positions in s contracts of the second type identified in step 301. A party “buying” one of these spread packages would obtain long positions in r first type contracts and short positions in s second type contracts. Conversely, a party “selling” one of these spread packages would obtain short positions in r first type contracts and long positions in s second type contracts.

In some embodiments, engine 201 determines r and s in step 312 from the weights stored in steps 310 and 311 by setting r=m*p and setting s=n*q. The current example assumes that engine 201 generates data defining an A/B spread package as having positions in three (1*3) type A contracts and four (2*2) type B contracts.

In some embodiments, and as part of step 312, engine 201 may also include data in a spread package type definition that defines how a price spread will be defined. In some cases, a price spread may be a simple difference between a trading price of a contract on one side of the spread (e.g., a type A contract in the current example) and a trading price of a contract on the other side of the spread (e.g., a type B contract in the current example). In some cases, a spread could defined as a ratio, e.g., a ratio of a trading price for a contract on one side of the spread to a trading price for a contract on the other side of the spread. Price spreads can be defined in other ways. In some embodiments, a user of computer 204 inputs data indicating how a price spread should be determined for spread packages of a defined spread package type. Engine 201 then includes that price spread definition in the spread package definition data.

In step 313, engine 201 forwards the spread package type definition to other modules of exchange computer system 100. Subsequently, and as a result of receiving the spread package type definition, instances of that spread package type can be bought and sold.

In at least some embodiments, spread packages are priced based on a price spread between the contracts on opposing legs of the package. For example, a trader wishing to purchase an A/B spread package from the above example would be seeking long positions in three type A contracts and short positions in four type B contracts. Instead of bidding for three type A contracts at a first price, calculating a second price based on the first price and a desired price spread, and separately offering to sell four type B contracts at the second price, the trader could simply bid the price spread. Such a bid could indicate a willingness to purchase three A contracts and sell four B contracts at current market prices, so long as the bid price spread is achieved. Conversely, a trader wishing to sell an A/B spread package could offer a price spread instead of separately offering three A contracts and bidding four B contracts. The exchange computer system could match A/B spread package bids to A/B spread package offers. Once matched, the exchange could then execute the trades and enter data in the traders' accounts indicating the traded positions.

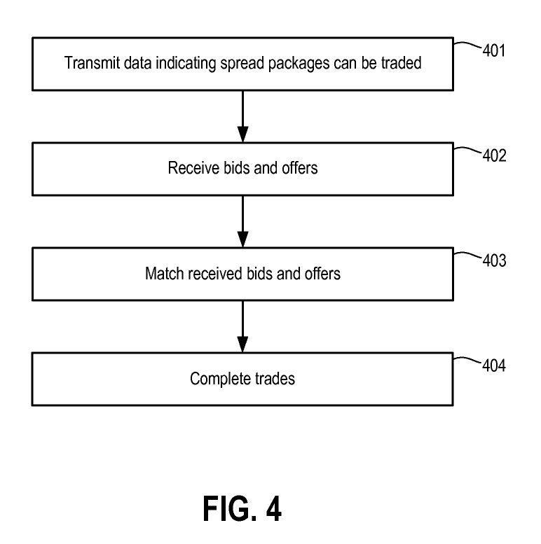

FIG. 4 is a block diagram illustrating operations associated with trading one or more instances of the spread package type created during the operations of FIGS. 3A and 3B. In step 401, the exchange computer system 100 (FIG. 1) transmits data indicating that spread packages of the created type can be traded. Continuing the current example, this transmitted data could indicate that A/B spread packages can be traded and could provide details of that package type (e.g., the manner in which a price spread is determined, the numbers of A and B positions in a package, etc.).

In step 402, computer system 100 receives bids and offers from traders for spread packages. Each of those bids and offers includes data specifying a price spread at which a trader wishes to buy or sell one or more spread packages. In the current example, and as indicated above, a bid could specify a price spread of an A/B spread package. This would indicate the trader is willing to buy three A contracts and sell four B contracts at the bid price spread. An offer could specify a price spread at which a trader is willing to sell an A/B spread package. This would indicate the trader is willing to sell three A contracts and buy four B contracts at the offered price spread.

In step 403, computer system 100 matches bids and offers received in step 402. In some cases, computer system 100 may match a bid to buy one or more of the spread packages at particular price with an offer to sell that same number of spread packages at the same price. In other cases, computer system 100 may perform trade matching against an implied spread by matching a bid (or an offer) for a spread package with bids and/or offers for “unpackaged” contracts of the types included in the package. For example, and continuing the current example, trader X might submit a bid for an A/B spread package at price spread $PS. Trader Y might submit and offer of three type A contracts at price $P1, while trader Z might submit a bid for four type contracts at price $P2. The price spread between $P1 and $P2, calculated according to the spread package definition, might be $PS. In such a circumstance, computer system 100 might match the bid of trader X to the offer of trader Y and the bid of trader Z.

In step 404, the computer system completes trades based on the matching in step 403 and stores data (e.g., in clearinghouse module 140) reflecting the resulting positions of the parties to the matched bid(s) and offer(s).

Other embodiments include numerous variations on the systems and methods described above. For example, an exchange in some embodiments could initially set prices of a spread package and/or could periodically revise such prices based on bid and ask prices associated with the contracts forming legs of the spread package. As another example, a trader bidding on a spread package could include additional information with the price spread at which the trader would like to buy or sell the package. As but one illustration thereof, a trader could bid for a spread package by specifying a price spread and a maximum contract price for the long leg(s), by specifying a price spread and a minimum contract price for the short leg(s), by specifying a range of price spreads, etc.

In the embodiments described in connection with FIGS. 3A and 3B, the weighting was performed so as to roughly balance the opposing sides of the spread based on notional value and based on risk. In other embodiments, the weighting may be performed so as to make the spread “unbalanced” to a desired degree. For example, one side of the spread could be weighted so as to make it riskier than the other side by a desired factor. As one illustration of this concept, engine 201 could be configured to choose p and q such that p*β₁=D*q*β₂, where D is the desired degree of increased risk. In some embodiments, weighting might only be performed with regard to risk factors.

Risk factors could be determined by techniques other than those described in connection with FIGS. 3A and 3B. For example, the time period T could be longer or shorter. Instead of basing a risk calculation on daily rates of return, a risk calculation could be based on weekly rates of return or based on rates of return over some other amount of time. Other types of statistical analyses could be used to quantify the extent to which a rate of return for a particular contract type subject matter varies relative to a benchmark index.

In some embodiments, operations such as those described in connection with FIGS. 3A and 3B could be repeated periodically (e.g., daily, weekly, monthly, bi-monthly, etc.). If the values of the calculated risk factors and/or of the calculated nominal values are found to have changed substantially, the spread package type definition could be modified as to subsequent spread packages.

As previously indicated, a spread package type based on futures contract types A and B was merely one example of a spread package type that could be created, and for which instances of thereof could be traded, according to various embodiments. Other examples of spread package types that could be created, for which instances thereof could be traded, include but are not limited to the following:
One side of a spread package could include one or more equity futures contracts in which the subject matter is stocks of companies in a first industry sector. The other side of the package could include one or more equity futures contracts in which the subject matter is stocks of companies in a different industry sector. The benchmark index could be a published stock market index.
One side of a spread package could include one or more equity index futures contracts in which the subject matter is a first published stock market index (e.g., the NASDAQ). The other side of the package could one or more equity index futures contracts in which the subject matter is a second published stock market index (e.g., the S&P 500). The benchmark index could be a third published stock market index (e.g., the DJIA).
One side of a spread package could include one or more equity index futures contracts in which the subject matter is a first published international stock market index (e.g., the NIKKEI 225). The other side of the package could one or more equity index futures contracts in which the subject matter is a second published international stock market index (e.g., the FTSE 100). The benchmark index could be a third published stock market index (e.g., the DJIA). Currency weightings or exchange rates could be introduced as a supplemental risk or weighting factor, e.g., USD index vs. currency translated Nikkei 225 index.
One side of a spread package could include one or more commodity futures contracts in commodity A that mature on a first date. The other side of the package could include one or more commodity futures contracts in commodity A that mature on a second date. The benchmark index could be a published commodities futures index or a published stock market index.
One side of a spread package could include one or more commodity futures contracts in commodity A. The other side of the package could include one or more commodity futures contracts in commodity B. The benchmark index could be a published commodities futures index or a published stock market index.
One side of a spread package could include one or more futures contracts for currency A (e.g., the European Euro). The other side of the package could include one or more futures contracts for currency B (e.g., the Japanese Yen). The benchmark index could be a value of currency C (e.g., the Chinese Yuan) relative to the U.S. Dollar.
A spread package could have dissimilar contracts on the opposing sides. For example, one side of a spread package could include one or more commodity futures contracts. The other side could include one or more equity index futures contracts. The benchmark index could be a published commodities futures index or a published stock market index.
Benchmark data other than a published index could be used. For example, a value of a predefined quantity of a commodity could be used as a benchmark. As another example, and as indicated above, a value of a currency relative to another currency could be used as a benchmark.

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that the steps illustrated in the illustrative figures may be performed in other than the recited order, and that one or more steps illustrated may be optional in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
retrieving contract type definition data for first type contracts and for second type contracts, the first type contracts being multi-laterally traded futures contracts based on a first subject matter and the second type contracts being multi-laterally traded futures contracts based on a second subject matter;
determining first and second factors by a computer system and based at least in part on the retrieved contract type definition data, the first factor being a relationship between rates of return based on the first subject matter relative to rates of return of benchmark data, and the second factor being a relationship between rates of return based on the second subject matter relative to rates of return of the benchmark data;
determining first and second integers based at least in part on the determined first and second relationships; and
transmitting spread package type definition data by a computer system, the spread package type definition data specifying the first integer quantity of the first type contract and the second integer quantity of the second type contract.

2. The method of claim 1, further comprising:
receiving spread package trade data at a computer system, the spread package trade data comprising price data for one or more spread packages conforming to the spread package type definition data, the price data specifying a price for the one or more spread packages as a price spread;
matching the received spread package trade data to other received trade data; and
storing data for trades of first type contracts and second type contracts resulting from the matching.

3. The method of claim 1, further comprising
determining a first notional value for the first contract type and a second notional value for the second contract type;
determining first and second notional value weights based at least in part on the determined first and second notional values; and
determining first and second risk weights based at least in part on the first and second factors, wherein
determining the first integer comprises multiplying the first notional value weight and the first risk weight, and
determining the second integer comprises multiplying the second notional value weight and the second risk weight.

4. The method of claim 3 wherein
determining first and second notional value weights comprises determining first and second notional value weights such that a product of the first notional value weight and the first notional value is approximately equal to a product of the second notional value weight and the second notional value, and
determining first and second risk weights comprises determining first and second risk weights such that a product of the first risk weight and the first factor is approximately equal to a product of the second risk weight and the second factor.

5. The method of claim 1 wherein
the first factor comprises the slope parameter βhd 1 in the univariate linear regression R₁(t)=α₁+β₁(R_{bench}(t)+ε₁ calculated over a time period T, wherein
R₁(t) is based on a change in value of the first subject matter, as of a time t during the period T, relative to a preceding period t−1,
R_{bench}(t) is based on a change in value of the benchmark data at time t relative to time t−1,
β₁ is a univariate linear regression slope term,
α₁ is a univariate linear regression intercept term, and
ε₁ is a univariate linear regression error term, and
the second factor comprises the slope parameter β₂ in the univariate linear regression R₂(t)=α₂ +β₂(R_{bench}(t))+ε₂ calculated over the time period T, wherein
R₂(t) is based on a change in value of the second subject matter, as of a time t during the period T, relative to a preceding period t−1,
β₂ is a univariate linear regression slope term,
α₂ is a univariate linear regression intercept term, and
ε₂ is a univariate linear regression error term.

6. The method of claim 1 wherein
the first subject matter is a first collection of stocks,
the second subject matter is a second collection of stocks, and
the benchmark index is a published stock market index.

7. The method of claim 1 wherein
the first subject matter is a first commodity,
the second subject matter is a second commodity,
the benchmark index is one of a published commodity futures index or a published stock market index.

8. One or more non-transitory computer-readable media storing computer executable instructions that, when executed, cause a computer system to perform operations that include:
retrieving contract type definition data for first type contracts and for second type contracts, the first type contracts being multi-laterally traded futures contracts based on a first subject matter and the second type contracts being multi-laterally traded futures contracts based on a second subject matter;
determining first and second factors based at least in part on the retrieved contract type definition data, the first factor being a relationship between rates of return based on the first subject matter relative to rates of return of benchmark data, and the second factor being a relationship between rates of return based on the second subject matter relative to rates of return of the benchmark data;
determining first and second integers based at least in part on the determined first and second relationships; and
transmitting spread package type definition data, the spread package type definition data specifying the first integer quantity of the first type contract and the second integer quantity of the second type contract.

9. The one or more non-transitory computer-readable media of claim 8 wherein the stored instructions further comprise instructions that, when executed, cause the computer system to perform operations that include:
receiving spread package trade data, the spread package trade data comprising price data for one or more spread packages conforming to the spread package type definition data, the price data specifying a price for the one or more spread packages as a price spread;
matching the received spread package trade data to other received trade data; and
storing data for trades of first type contracts and second type contracts resulting from the matching.

10. The one or more non-transitory computer-readable media of claim 8 wherein the stored instructions further comprise instructions that, when executed, cause the computer system to perform operations that include:
determining a first notional value for the first contract type and a second notional value for the second contract type;
determining first and second notional value weights based at least in part on the determined first and second notional values; and
determining first and second risk weights based at least in part on the first and second factors, wherein
determining the first integer comprises multiplying the first notional value weight and the first risk weight, and
determining the second integer comprises multiplying the second notional value weight and the second risk weight.

11. The one or more non-transitory computer-readable media of claim 10 wherein
determining first and second notional value weights comprises determining first and second notional value weights such that a product of the first notional value weight and the first notional value is approximately equal to a product of the second notional value weight and the second notional value, and
determining first and second risk weights comprises determining first and second risk weights such that a product of the first risk weight and the first factor is approximately equal to a product of the second risk weight and the second factor.

12. The one or more non-transitory computer-readable media of claim 8 wherein
the first factor comprises the slope parameter β₁ in the univariate linear regression R₁(t)=α₁+β₁(R_{bench}(t)+ε₁ calculated over a time period T, wherein
R₁(t) is based on a change in value of the first subject matter, as of a time t during the period T, relative to a preceding period t−1,
R_{bench}(t) is based on a change in value of the benchmark data at time t relative to time t−1,
β₁ is a univariate linear regression slope term,
α₁ is a univariate linear regression intercept term, and
β₁ is a univariate linear regression error term, and
the second factor comprises the slope parameter fl₂ in the univariate linear regression R₂(t)=α₂+β₂(R_{bench}(t))+ε₂ calculated over the time period T, wherein
R₂(t) is based on a change in value of the second subject matter, as of a time t during the period T, relative to a preceding period t−1,
β₂ is a univariate linear regression slope term,
α₂ is a univariate linear regression intercept term, and
ε₂ is a univariate linear regression error term.

13. The one or more non-transitory computer-readable media of claim 8 wherein
the first subject matter is a first collection of stocks,
the second subject matter is a second collection of stocks, and
the benchmark index is a published stock market index.

14. The one or more non-transitory computer-readable media of claim 8 wherein
the first subject matter is a first commodity,
the second subject matter is a second commodity,
the benchmark index is one of a published commodity futures index or a published stock market index.

15. A computer system comprising:
at least one processor; and
at least one non-transitory memory, wherein the at least one non-transitory memory stores instructions that, when executed, cause the computer system to perform operations that include
retrieving contract type definition data for first type contracts and for second type contracts, the first type contracts being multi-laterally traded futures contracts based on a first subject matter and the second type contracts being multi-laterally traded futures contracts based on a second subject matter,
determining first and second factors based at least in part on the retrieved contract type definition data, the first factor being a relationship between rates of return based on the first subject matter relative to rates of return of benchmark data, and the second factor being a relationship between rates of return based on the second subject matter relative to rates of return of the benchmark data,
determining first and second integers based at least in part on the determined first and second relationships, and
transmitting spread package type definition data, the spread package type definition data specifying the first integer quantity of the first type contract and the second integer quantity of the second type contract.

16. The computer system of claim 15 wherein the at least one non-transitory memory stores instructions that, when executed, cause the computer system to perform operations that include
receiving spread package trade data, the spread package trade data comprising price data for one or more spread packages conforming to the spread package type definition data, the price data specifying a price for the one or more spread packages as a price spread,
matching the received spread package trade data to other received trade data, and
storing data for trades of first type contracts and second type contracts resulting from the matching.

17. The computer system of claim 15 wherein the at least one non-transitory memory stores instructions that, when executed, cause the computer system to perform operations that include
determining a first notional value for the first contract type and a second notional value for the second contract type,
determining first and second notional value weights based at least in part on the determined first and second notional values, and
determining first and second risk weights based at least in part on the first and second factors, wherein
determining the first integer comprises multiplying the first notional value weight and the first risk weight, and
determining the second integer comprises multiplying the second notional value weight and the second risk weight.

18. The computer system of claim 17 wherein
determining first and second notional value weights comprises determining first and second notional value weights such that a product of the first notional value weight and the first notional value is approximately equal to a product of the second notional value weight and the second notional value, and
determining first and second risk weights comprises determining first and second risk weights such that a product of the first risk weight and the first factor is approximately equal to a product of the second risk weight and the second factor.

19. The computer system of claim 15 wherein
the first factor comprises the slope parameter β₁ in the univariate linear regression R₁(t)=α₁+β₁(R_{bench(t)+ε}₁ calculated over a time period T, wherein
R₁(t) is based on a change in value of the first subject matter, as of a time t during the period T, relative to a preceding period t−1,
R_{bench}(t) is based on a change in value of the benchmark data at time t relative to time t−1,
β₁ is a univariate linear regression slope term,
α₁ is a univariate linear regression intercept term, and
ε₁ is a univariate linear regression error term, and
the second factor comprises the slope parameter β₂ in the univariate linear regression R₂(t)=α₂+β₂(R_{bench}(t))+ε₂ calculated over the time period T, wherein
R₂(t) is based on a change in value of the second subject matter, as of a time t during the period T, relative to a preceding period t−1,
β₂ is a univariate linear regression slope term,
α₂ is a univariate linear regression intercept term, and
ε₂ is a univariate linear regression error term.
